(19) United States
(12) Patent Application Publication
(10) Pub. No.: US 2026/0338089 A1
(43) Pub. Date: Oct. 29, 2026

(54) TOOLING ADAPTER PLATES

(71) Applicant: RTX Corporation, Farmington, CT (US)

(72) Inventor: Christopher E. Shomaker, Elizabethton, TN (US)

(73) Assignee: RTX Corporation, Farmington, CT (US)

(21) Appl. No.: 19/189,419

(22) Filed: Apr. 25, 2025

(51) Int. Cl. F01D 25/28; B25H 1/00

(52) U.S. Cl. CPC F01D 25/285; B25H 1/0007; F05D 2220/32; F05D 2230/68; F05D 2230/72; F05D 2260/02

(57) ABSTRACT

An apparatus for adapting a build stand includes a plate structure having a lower side configured to mount to a first build stand configuration, and an upper side configured to present a different build stand configuration. The adapter convert a build stand that is suitable for the mounting structure of one engine assembly to receive a different mounting structure of a different engine assembly that that is not otherwise compatible with the build stand.

### FIELD

The present disclosure relates to an adapter plate for build stands, for example for assembling engine hardware.

### BACKGROUND

Large and heavy industrial machinery such as engines of various types including gas turbine engines can require specialized build stands for assembly and disassembly.

The design of the build stands can be specialized for a specific type of engine, and at times a different engine needs to be assembled or disassembled. When the different engine is not compatible with the most commonly used build stand, there can be a backup or bottleneck caused by too much demand for a specific build stand while other build stands can sit idle.

The need exists for a way to expand full utilization of all build stands in a particular assembly/disassembly facility.

### SUMMARY OF THE DISCLOSURE

The present disclosure is directed to a tooling adapter plate that can be used to convert a build stand designed for one type of engine, engine component or engine assembly to be compatible for working on a different engine, engine component or engine assembly.

In one non-limiting embodiment, an apparatus for adapting a build stand comprises a plate structure having a lower side configured to mount to a first build stand configuration, and an upper side configured to present a different build stand configuration.

In one non-limiting configuration, a lower side configuration of the plate structure comprises lower a radial ring, and wherein an upper side configuration of the plate structure comprises an upper radial ring of different size than the lower radial ring.

In another non-limiting configuration, the upper radial ring has an inner radial surface and the lower radial ring has an outer radial surface, and wherein the inner radial surface and the outer radial surface have different radii.

In still another non-limiting configuration, the plate structure is defined by a plurality of ring segments.

In a further non-limiting configuration, the plurality of the ring segments define a full ring when assembled.

In a still further non-limiting configuration, the plurality of the ring segments are mounted individually to a build stand having the first build stand configuration, and when mounted have spaces defined between the ring segments.

In another non-limiting configuration, the plurality of the ring segments comprises between 2 and 12 ring segments.

In still another non-limiting configuration, the plate structure is defined by a full ring.

In another non-limiting embodiment, a build stand assembly, comprises a first build stand having a first inner radial surface for receiving mounting structure of a first engine assembly to allow work on the first engine assembly in an upright position; an adapter comprising a plate structure having a lower side mounted to the first build stand, and an upper side configured to present a second inner radial surface having a different radius than the first inner radial surface, whereby a second engine assembly having a mounting structure incompatible with the first build stand can be mounted to the adapter.

In one non-limiting configuration, the adapter is engaged with the first inner radial surface of the first build stand.

In another non-limiting configuration, the mounting structure of the second engine assembly is engaged with the second inner radial surface.

In still another non-limiting configuration, the plate structure is defined by a plurality of ring segments.

In a further non-limiting configuration, the plurality of the ring segments define a full ring when assembled.

In a still further non-limiting configuration, the plurality of the ring segments are mounted individually to a build stand having the first build stand configuration, and when mounted have spaces defined between the ring segments.

In another non-limiting configuration, the plurality of the ring segments comprises between 2 and 12 ring segments.

In still another non-limiting configuration, the plate structure is defined by a full ring.

In another non-limiting embodiment, a method for converting a build stand to accept an incompatible engine assembly comprises the steps of mounting an adapter plate to build stand having a first inner radial surface for receiving mounting structure of a first engine assembly to allow work on the first engine assembly in an upright position, wherein the adapter comprises a plate structure having a lower side, and the mounting comprises mounting the lower side to the first build stand, wherein the adapter plate further comprises an upper side configured to present a second inner radial surface having a different radius than the first inner radial surface, and mounting a second engine assembly having a mounting structure incompatible with the first build stand to the upper side of the adapter.

In one non-limiting configuration, the method further comprises performing an assembly or maintenance operation on the second engine assembly while mounted to the adapter.

In another non-limiting configuration, the adapter plate is defined by a plurality of ring segments.

In still another non-limiting configuration, the adapter plate is defined by a full ring.

The foregoing features and elements may be combined in various combinations without exclusivity, unless expressly indicated otherwise. These features and elements, as well as the operation thereof, will become more apparent in light of the following description and the accompanying drawings. It should be appreciated that the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 schematically illustrates in exploded form a build stand with engine assembly.

FIG. 2 is a side and still exploded view of the build stand and engine assembly of FIG. 1.

FIGS. 3-5 illustrate one non-limiting configuration of a build stand and engine assembly with an adapter for compatibility.

FIG. 6 is a cross-section of a portion of an adapter with adjacent components of a build stand and engine assembly.

FIG. 7 illustrates features of another non-limiting embodiment of an adapter.

FIGS. 8-10 illustrate features of another non-limiting embodiment of an adapter.

### DETAILED DESCRIPTION

The detailed description of embodiments herein makes reference to the accompanying drawings, which show embodiments by way of illustration. While these embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not for limitation. For example, any reference to singular includes plural embodiments, and any reference to more than one component or step may include a singular embodiment or step. Also, any reference to attached, fixed, connected or the like may include permanent, removable, temporary, partial, full and/or any other possible attachment option. Further, any steps in a method discussed herein may be performed in any suitable order or combination. Additionally, any reference to without contact (or similar phrases) may also include reduced contact or minimal contact. It should also be understood that unless specifically stated otherwise, references to “a”, “an”, or “the” may include one or more than one and that reference to an item in the singular may also include the item in the plural. Further, all ranges may include upper and lower values and all ranges and ratio limits disclosed herein may be combined.

This disclosure relates to build stands for assembly and/or servicing of large industrial equipment such as, for example, engines such as gas turbine engines. These engines contain many components that are considerably heavy and rotate, or have parts that rotate, around an axis such that the best position to work on the assembly is with an axis of rotation in a vertical orientation, which is also referred to herein as an upright position. In order to position the engine or other assembly in this orientation and hold it securely in place while the intended work is done, build stands are used which cooperate with mounting structure of the engine assembly to firmly receive the engine or other assembly in the desired orientation. Facilities for assembly and maintenance of engines or other industrial equipment must frequently have a number of different build plates to accommodate different assemblies. As demands change, some build stands are more compatible with incoming work orders than others. This can lead to bottlenecks in assembly processes. This disclosure is directed to an adapter plate structure or assembly that can be used to adapt a build stand of one configuration into a different, potentially more useful, configuration.

In one instance, it is desirable to adapt a build stand to accept work such as engine core work for a type of engine with which the build stand would not normally be compatible. In one non-limiting configuration, this adaptation enables moving core engine work out of the larger build cell of a plant facility. Engine core work is often time intensive and can drive bottle necks in workflow on a shop floor. By moving this maintenance out of that cell and to a more centralized location module, production can be increased.

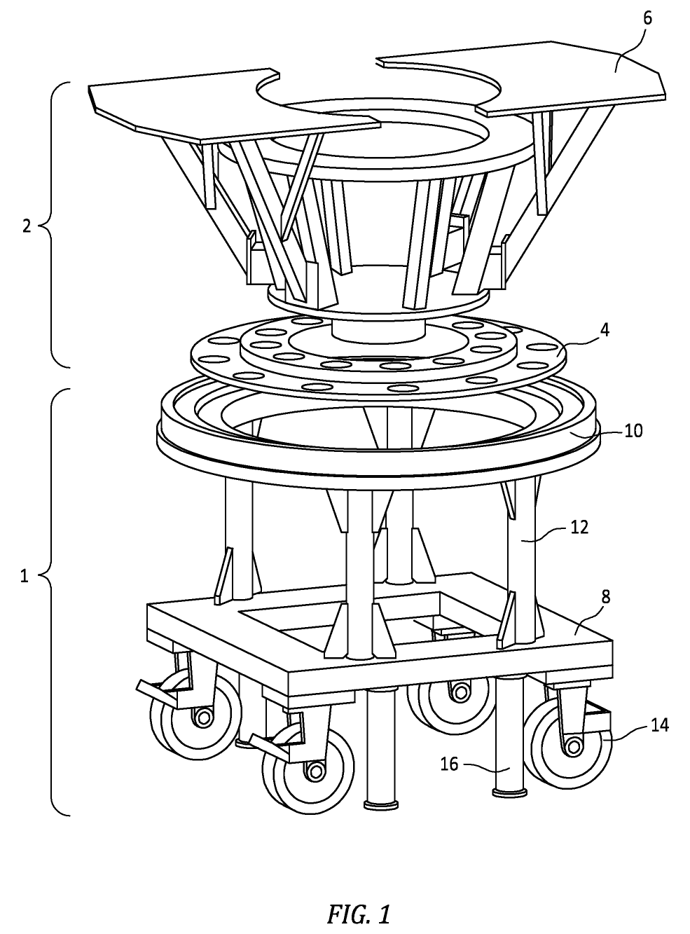

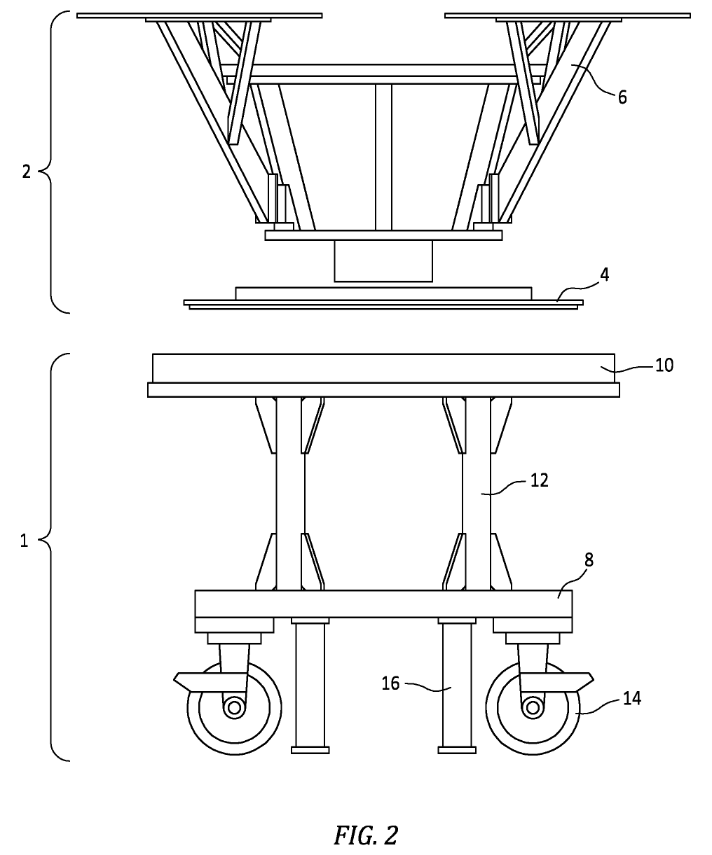

FIGS. 1 and 2 show, in an exploded view, a build stand 1 supporting an engine or engine assembly 2. The engine assembly 2 in this configuration is illustrated as two components 4, 6 that are actually mounting structures for the engine assembly, and are designed to support one type of gas turbine engine in an upright position during assembly or maintenance. Components 4, 6 engage with the underlying builds stand in order to provide for a stable upright mounting of an engine assembly on the underlying build stand. Build stand 1 has a support structure such as frame 8 and a ring 10 supported on frame 8 in this case by a plurality of vertical columns 12. Frame 8 can be supported on a ground or work surface by wheel structures 14 and/or additional columns 16. The actual support of frame 8 on a work surface is not critical, as long as the frame is sufficiently stable to hold heavy workpieces during assembly and related processes.

The combination of stand 1 and engine assembly 2 as shown in FIGS. 1 and 2 is compatible because the contours of component 4 of the mounting structure match with those of ring 10. Thus, component 4 can be mounted to ring 10 and work conducted on engine assembly 2 as desired. As mentioned above, when a build stand such as build stand 1 is in high demand, for example when engine assemblies having components such as components 4, 6 are needed to be worked on in high volume, it is desirable to be able to use other build stands to allow such work to be done greater in parallel. In addition, it would be advantageous to be able to work on engine assemblies at a convenient height for workers standing on the same floor or support surface as supports build stand 1. As can best be seen in FIG. 2, the structure of build stand 1 positions ring 10 at an elevated height, which can be desirable for engine assemblies that hang down from a mount to ring 10. However, for engine assemblies such as those supported by mounting structure such as components 4, 6, workers must now use a ladder or the like to climb to the height of the work to be done.

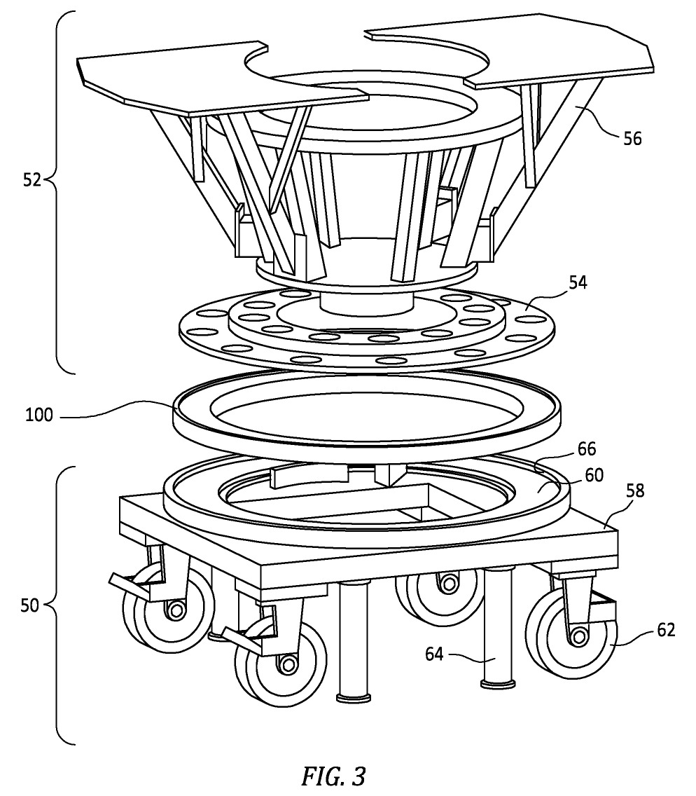

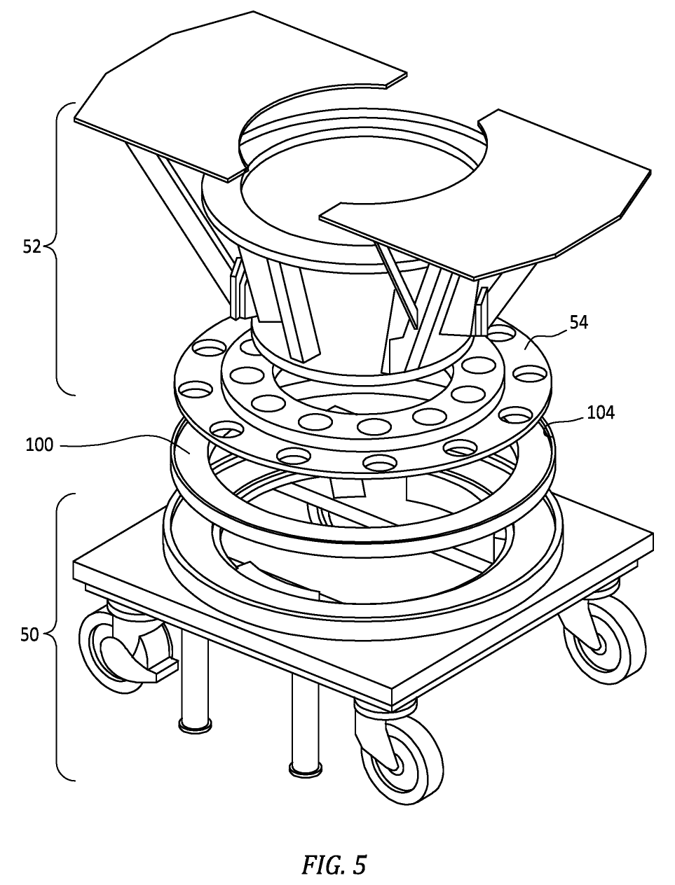

FIGS. 3-5 show a build stand 50 for supporting an engine assembly 52, and an adapter 100 which can be used to convert build stand 50 to be compatible with components 54, 56 of engine assembly 52. This expands the usefulness of stand 50 to be able to support additional engine assemblies. FIGS. 3-5 show engine assembly components 54, 56 which are the same as those shown in FIGS. 1-2. Build stand 50 has a frame 58 and a ring 60 mounted to frame 58. Wheels 62 and/or columns 64 can support frame 58 on a work surface. In this configuration, component 54 is not compatible with ring 60, and therefore build stand 50 would not normally be compatible with this engine assembly 52. This is because the contours and shapes of ring 60 do not match the shape of component 54. In some configurations, ring 60 is mounted rotatably to frame 58 to further assist in proper positioning of the workpiece or engine assembly for ease of access.

As further described below, however, in this configuration, adapter 100 is adapted to have a lower structure that mates with that of ring 60, and an upper structure that mates with that of component 54. In this way, adapter 100 can be mounted to ring 60 and build stand 50 is thereby converted to being compatible with engine assembly 52.

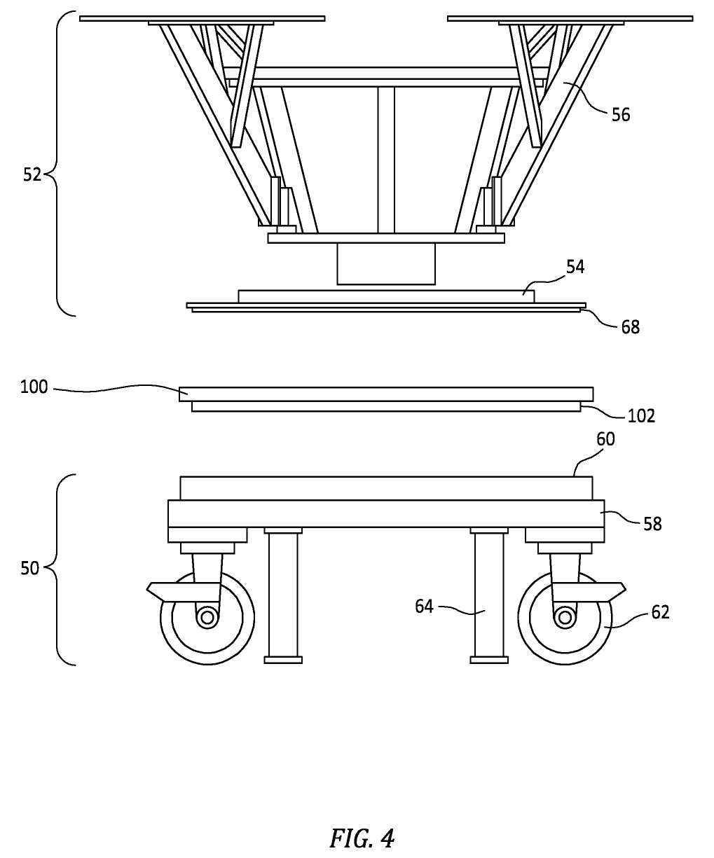

One feature of ring 60 and component 54 that is generally used for each component to allow for mounting of these structures to each other is a radial wall configuration whereby, for example, the ring 60 has an inner radial wall 66 (FIG. 3) that is intended to mate with an outer radial wall 68 (FIG. 4) of component 54. In this case, however, walls 66, 68 do not have the same diameter or radius. To resolve this issue, adapter 100 can have a lower side having an outer radial wall 102 (FIG. 4) which is sized and configured to mate with inner radial wall 66 of ring 60. Adapter 100 can also have an upper side with an inner radial wall 104 which is sized and configured to mate with the outer radial wall 68 of component 54. By mounting adapter 100 to build stand 50, build stand 50 can now be used to support engine assembly 52 as desired. It should also be appreciated that since build stand 50 is not intended in other uses to support an engine hanging downward from ring 60, there are no vertical columns supporting ring 60 at a higher elevation as in the configuration of FIGS. 1-2. Thus, engine assembly 52 in the configuration of FIGS. 3-5 is supported in a lower, more reachable, location than it would be with the stand 1 of FIGS. 1-2. This allows workers to access and work on an industrial assembly such as a gas turbine engine in a way that is more in line with expected safety standards and the like, for example by not requiring a ladder to reach the height of the work to be done.

Adapter 100 can be a full ring structure as is illustrated in FIGS. 3-5, or it can be a plurality of ring segments as will be described below.

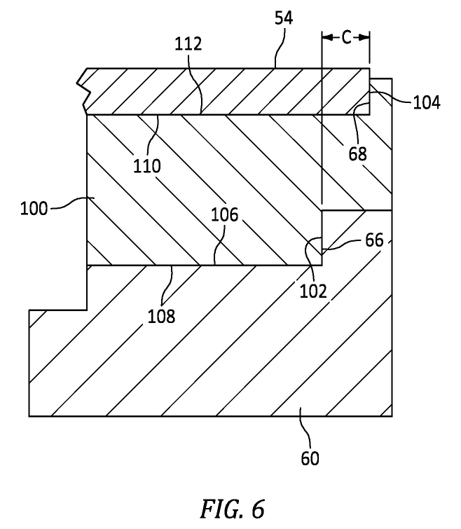

FIG. 6 further illustrates interaction between ring 60, adapter 100 and component 54 through a cross section taken through the components when they are assembled. As shown, adapter 100 has lower surface 106 which can but does not need to rest on an upper surface 108 of ring 60. At lower surface 106, adapter defines outer radial wall 102 that is sized to engage within inner radial wall 66 of ring 60. Adapter 100 further has an upper surface 110 that can but does not need to rest against a lower surface 112 of component 54. In addition, inner radial wall 104 of adapter 100 is defined at the upper surface 110 and is configured to engage with outer radial wall 68 of component 54. The difference in radius of walls 102, 104 of adapter is shown with a correction or adjustment factor C to provide for a clear understanding of the adaptation that can be accomplished using adapter 100 with a build stand such as build stand 50. Adapter 100 can be provided with mounting structure to allow mounting to a build stand. This can be with bolt holes through the adapter plate to that are aligned with bolt holes on the build stand.

Adapter 100 can be in the form of a complete ring as shown in the embodiment of FIGS. 3-5 as one non-limiting embodiment. In other configurations, adapter 100 can be an assembly of a plurality of ring segments. Any number of ring segments can be used so long as they can support the engine assembly in a stable manner. As long as each segment is sufficiently long, this could be done with even just two segments, which could have spaces between edges thereof, or which could combine to form a complete ring. In another configuration, there can advantageously be between 2 and 12 segments, and within this range, between 4 and 6 segments.

When there are a plurality of segments, each segment should have some mechanism for mounting to the underlying build stand. This can be in the form of clamps, bolt assemblies and the like.

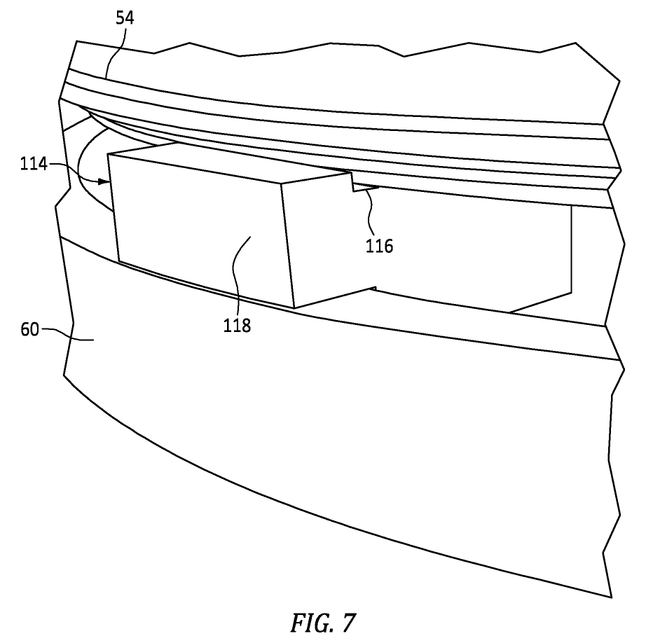

Turning now to FIG. 7, another configuration is illustrated wherein adapter 100 is provided as a plurality of narrow wedge shaped segments 114. The arc of each segment 114 in this case is relatively small, for example between about 10 and 30 degrees of the full circle. Each segment defines a radially inner wall 104 on an upper surface and a radially outer wall 102 on a lower surface to engage with component 54 and ring 60 respectively. In addition, in this configuration, segments 114 have an upper surface 116 defined radially inwardly from inner radial wall 104. Surface 116 helps to support the mounting structure to be mounted, and to distribute the weight of the engine assembly over greater surface area.

Each segment should have a means by which it can be fastened to, or relative to, underlying ring 60. This can be in the form of a laterally extending flange with bolt hole, or a bolt hole disposed through the head portion 118 of segment 114, or any other mechanism that would be known to a person having ordinary skill in the art.

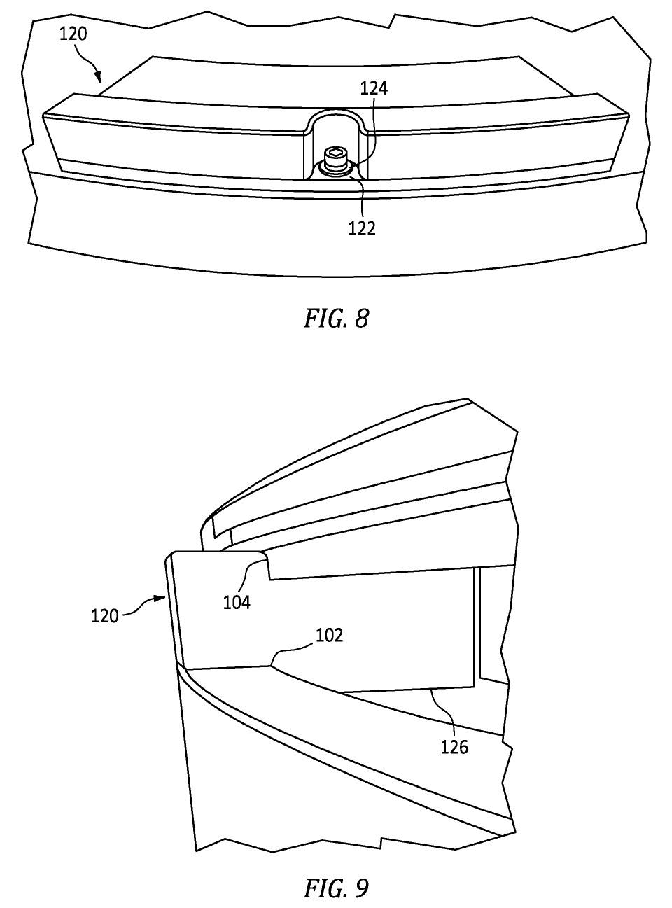

FIGS. 8-10 illustrates another non-limiting configuration wherein adapter is again defined by a plurality of segments 120, but in this case the segments extend to a greater degree of the arc of the circle, for example in the range of 30-60 degrees of the arc of a circle. Segments 120 still define inner radial wall 104 and outer radial wall 102 for interacting with component 54 and ring 60 respectively. Depending upon the number and segment length of each segment 120, the plurality of segments 120 can be assembled to form a complete ring, or can be assembled with gaps defined along the circumference between each segment 120. In this regard, there are advantages in each configuration. When forming a complete circle, the stability of the overall adapter can be greater. On the other hand, with smaller segments that define gaps therebetween, less material and accordingly less weight are involved in the adapter. Further, with gaps between the segments, there is room to reposition each segment to a small degree, as necessary, to accommodate any irregularities in component 54 and/or ring 60.

The configuration of FIGS. 8-10 illustrates a different configuration of other walls or surfaces of this adapter, see for example that in this configuration the upper wall of segments 120 is substantially horizontal as in the embodiment of FIG. 7. In addition, in this configuration, the embodiment of FIGS. 8-10 shows a lower surface 126 of segments 120 that can be oriented to extend radially inwardly and provide greater support for the adapter on the underlying frame.

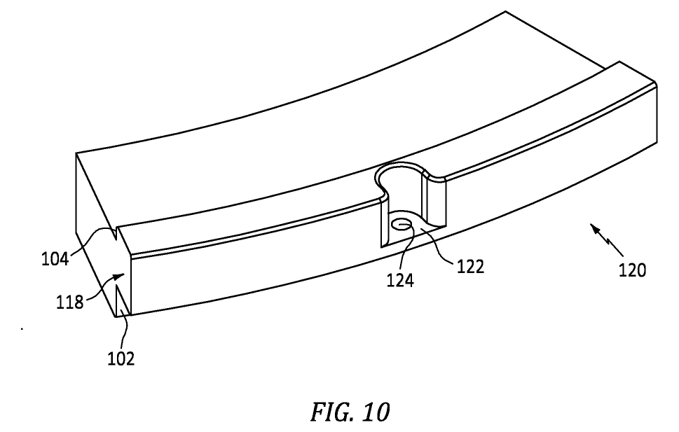

FIG. 10 also clearly illustrates one of the mechanisms by which the adapter is mounted to the underling build stand, in this case with a flattened portion 122 defined in head portion 118 of segments 120, and with a bolt hole 124 defined through flattened portion 122. Thus, this configuration of segments 120 can be secured to ring 60 using bolts passing through bolt holes 124 and engaged with corresponding bores in ring 60.

It should be appreciated that adapter 100 according to this disclosure can be provided of many possible materials, including steel, other alloys, and high temperature thermoplastics.

In use, adapter 100 according to the various embodiments disclosed herein can advantageously be used to ease bottlenecks at certain build machines. Assume an assembly plant that has four build stands, but only one of the four is of the configuration of FIG. 1. If an order of a multiple of engine assemblies having the configuration of engine assembly 2, 52 is received, this multiple of engine assemblies will have to wait in line to be processed at the one compatible build stand while, potentially, the other three (3) build stands sit empty. By using adapters 100 as disclosed herein, however, the other non-compatible build stands can be made compatible, and the work order can proceed in parallel on all four build stands in the assembly plant. This can be done by installing the adapter plate as disclosed herein to the non-compatible build stands, and then placing the adapter and build stand back in operation to process the engine assemblies as desired, for example allowing assembly, disassembly and/or maintenance operations to be conducted on an engine assembly that would not normally be compatible with the build stand to which it is mounted through the adapter as disclosed herein.

The adapter as disclosed herein can be used to adapt the contours and different diametrical requirements of incompatible tools to enhance assembly line flexibility. It also enables greater compliance in environmental health and safety considerations as technicians no longer need to work on elevated build stands or ladders to execute engine core maintenance on certain types of engines.

It should be appreciated that when an engine assembly is referred to herein, this can refer, without limitation, to an actual engine assembly, or to an engine mounted in other components to hold the engine, such as components 54, 56. Further, the engine assembly can be an assembly of a gas turbine engine, other types of engines, compressors, turbines and many other types of roto machinery of industrial equipment, typically sufficiently large that stable mounting is needed to support the assembly while being worked on.

The foregoing description is exemplary of the subject matter of the subject matter disclosed herein. Various non-limiting embodiments are disclosed, however, one of ordinary skill in the art would recognize that various modifications and variations in light of the above teachings will fall within the scope of the appended claims. It is therefore to be appreciated that within the scope of the appended claims, the disclosure may be practiced other than as specifically described. Thus, the scope of the present claims is not specifically limited by the details of specific embodiment disclosed herein, but rather the claims define the full and reasonable scope of the disclosure.

We claim:

1. An apparatus for adapting a build stand, comprising:
a plate structure having a lower side configured to mount to a first build stand configuration, and an upper side configured to present a different build stand configuration.

2. The apparatus of claim 1, wherein a lower side configuration of the plate structure comprises a lower radial ring, and wherein an upper side configuration of the plate structure comprises an upper radial ring of different size than the lower radial ring.

3. The apparatus of claim 1, wherein the upper radial ring has an inner radial surface and the lower radial ring has an outer radial surface, and wherein the inner radial surface and the outer radial surface have different radii.

4. The apparatus of claim 1, wherein the plate structure is defined by a plurality of ring segments.

5. The apparatus of claim 4, wherein the plurality of the ring segments define a full ring when assembled.

6. The apparatus of claim 4, wherein the plurality of the ring segments are mounted individually to a build stand having the first build stand configuration, and when mounted have spaces defined between the ring segments.

7. The apparatus of claim 4, wherein the plurality of the ring segments comprises between 2 and 12 ring segments.

8. The apparatus of claim 1, wherein the plate structure is defined by a full ring.

9. A build stand assembly, comprising:
a first build stand having a first inner radial surface for receiving mounting structure of a first engine assembly to allow work on the first engine assembly in an upright position;
an adapter comprising a plate structure having a lower side mounted to the first build stand, and an upper side configured to present a second inner radial surface having a different radius than the first inner radial surface, whereby a second engine assembly having a mounting structure incompatible with the first build stand can be mounted to the adapter.

10. The assembly of claim 9, wherein the adapter is engaged with the first inner radial surface of the first build stand.

11. The assembly of claim 9, wherein the mounting structure of the second engine assembly is engaged with the second inner radial surface.

12. The assembly of claim 9, wherein the plate structure is defined by a plurality of ring segments.

13. The assembly of claim 12, wherein the plurality of the ring segments define a full ring when assembled.

14. The assembly of claim 12, wherein the plurality of the ring segments are mounted individually to a build stand having the first build stand configuration, and when mounted have spaces defined between the ring segments.

15. The assembly of claim 12, wherein the plurality of the ring segments comprises between 2 and 12 ring segments.

16. The assembly of claim 9, wherein the plate structure is defined by a full ring.

17. A method for converting a build stand to accept an incompatible engine assembly, comprising the steps of:
mounting an adapter plate to build stand having a first inner radial surface for receiving mounting structure of a first engine assembly to allow work on the first engine assembly in an upright position, wherein the adapter comprises a plate structure having a lower side, and the mounting comprises mounting the lower side to the first build stand, wherein the adapter plate further comprises an upper side configured to present a second inner radial surface having a different radius than the first inner radial surface, and
mounting a second engine assembly having a mounting structure incompatible with the first build stand to the upper side of the adapter.

18. The method of claim 17, further comprising performing an assembly or maintenance operation on the second engine assembly while mounted to the adapter.

19. The method of claim 17, wherein the adapter plate is defined by a plurality of ring segments.

20. The method of claim 17, wherein the adapter plate is defined by a full ring.
